(19) United States
(12) Patent Application Publication
(10) Pub. No.: US 2019/0010674 A1
(43) Pub. Date: Jan. 10, 2019

(54) Polymer Circular Manhole Assembly System

(71) Applicant: Yoon Ho CHOI, Daegu (KR)

(72) Inventor: Yoon Ho CHOI, Daegu (KR)

(21) Appl. No.: 16/068,467

(22) PCT Filed: Nov. 15, 2016
(86) PCT No.: PCT/KR2016/013150

§ 371 Date: Jul. 6, 2018

(30) Foreign Application Priority Data
Jan. 7, 2016 (KR) 10 2016 0002210
May 16, 2016 (KR) 10 2016 0059499

(51) Int. Cl. E02D 29/14

(52) U.S. Cl. CPC E02D 29/1463; E05Y 2900/612; E02D 2200/15; E02D 29/1436

(57) ABSTRACT

In the present invention, when a circular lid body is opened or closed by a hinge-coupling structure at an eccentric location out of a circle, the circular lid body can be opened or closed without interference between an edge protrusion part of the circular lid body and a circular edge support frame of a support frame body. Therefore, the present invention is useful in that the present invention has overcome innumerable interferences on arcs through a curve insertion scheme of a circular structure, that is, a curve insertion scheme by a rotational inclination angle θ of the edge protrusion part and an operation model view of an S-shaped hinge curve part.

### TECHNICAL FIELD

The present invention relates to a polymer circular manhole assembly, which prevents lid body separation due to back flow, which can be inserted by a curve insertion scheme without interference between a circular edge protrusion of a lid body and a circular edge support frame of a support frame body, and a circular manhole assembly thereof and in the present invention, when a circular lid body 30 is opened or closed by a hinge-coupling structure at an eccentric location out of a circle, the circular lid body 30 can be opened or closed without interference between an edge protrusion part 31 of the circular lid body 30 and a circular edge support frame 12 of a support frame body 10 and the present invention has overcome innumerable interferences on arcs through a curve insertion scheme of a circular structure, that is, a curve insertion scheme by a rotational inclination angle θ of the edge protrusion part 31 and an operation model view of an S-shaped hinge curve part 33.

In addition, an operation model view of the S-shaped hinge curve part 33 is made to be a curve formed by a mutual relationship with a center line (vertical line) of a circumferential center M, and as a result, it is easy to obtain a rotational inclination angle θ of a third equal splitting point without interference of the edge protrusion part 31 depending on length changes ΔX and ΔZ of the S-shaped hinge curve part 33, and the rotational inclination angle without interference of the edge protrusion part 31 of an n-th equal splitting point of each of respective three equally divided points (M-S1, S1-S2, . . . ) is obtained and is sequentially added and subtracted and distributed by each Δθ/n obtained by n-dividing a difference inclination angle Δθ in rotational inclination angle between both three divided points to easily obtain an entire rotational inclination angle of the edge protrusion part 31 through the three equally divided points.

### BACKGROUND ART

During a heavy rain period in a rainy season, a volume of rainfall increases rapidly.

A rapidly increased rainfall volume has exceeded a limit of a drainage capacity drained through a manhole.

The limit of the drainage capacity is already exceeded from a drain pipe connected to the manhole.

When the drainage capacity is exceeded, the rainfall will flow back through a manhole lid.

The reason is that there is no more drainage outlet.

Backflow is force in a vertical direction. The vertical force of the backflow ejects and separates the manhole lid from a manhole lid support frame. The reason is that a typical manhole we encounter around life is in a state in which the manhole lid is just closed without any restraint.

The ejection and separation of the manhole lid is a fatal risk to a vehicle and a pedestrian.

In order to prevent such a risk, it is important that the manhole lid should not be ejected and separated even if the manhole lid is opened due to the backflow, and it is important to maintain the originally closed state after the backflow.

As prior art therefor, Korean Patent Registration No. 10-0835530 (hereinafter referred to as “prior art”) developed by the present applicant is representative.

Korean Patent Registration No. 10-0835530 (hereinafter referred to as “prior art”) is a technology for a rectangular manhole structure.

The prior art is a structure in which the rectangular manhole lid is opened and closed by a hinge coupling structure in a rectangular manhole lid support frame. The prior art is an opening and closing structure in which the manhole lid support frame and a protrusion part of the manhole lid do not interfere with each other. The reason is that the protrusion part is formed in both the manhole lid support frame and the manhole lid.

As illustrated in FIG. 1A, a side protrusion part 15 of a manhole lid 10 and a side frame 24 of the manhole lid support frame 20 are straight protrusion parts and are parallel to each other.

Insertion of the side frame 24 of the manhole lid support frame 20 of the side protrusion part 15 of the manhole lid 10 is a straight line insertion scheme.

There is no front protrusion part in the manhole lid 10. A front part is opened.

Since the front part of the manhole lid 10 is opened and the insertion scheme of the side protrusion part 15 is a straight scheme, the rectangular manhole structure in the related art extremely simplifies an interference cause between the protrusion part of the manhole lid 10 and a protrusion frame of the manhole lid support frame 20.

In such a simplified straight line insertion scheme, when the manhole lid 10 rotates, it is important that the manhole lid 10 rotates smoothly without interference of a rear protrusion part 16 of the manhole lid 10 in a rear frame 23 of the manhole lid support frame 20.

The hinge-coupling structure of the prior art is merely a structure for rearward rotation of the hinge-coupling.

The reason is that the interference of the protrusion part occurs only on the hinge-coupled rear surface in the straight line insertion scheme in which the front part is opened.

The hinge-coupling structure in the prior art of the straight line insertion scheme in which the front part is opened is a structure configured by an S-shaped hinge groove 30 and hinge projection portion 40.

In FIG. 1B, a state in which the hinge projection portion 40 is located at point O of the S-shaped hinge groove 30 is a state of the manhole lid 10.

When the manhole lid 10 is opened as illustrated in FIG. 1C, the hinge projection portion 40 moves to point P. In this case, the manhole lid 10 is advanced forward and lifted up. When the manhole lid 10 rotates as illustrated in FIG. 1D, corners Q and R of the manhole lid 10 are prevented from being disturbed by the rear frame 23 and a bottom surface of the manhole lid support frame 20.

In this case, the advance of both side protrusion parts 15 and 15 of the manhole lid 10 while moving to point P is opening in a straight direction which is the same as straight directions of both side frames 24 and 24 of the manhole lid support frame 20.

The advance of both side protrusion parts 15 and 15 in the straight direction opens the manhole lid 10 while not interfering with both side frames 24 and 24 in the straight direction.

When the manhole lid 10 is opened while the manhole lid 10 is completely closed, the front part is opened even though both protrusion parts 15 and 15 are gradually advanced, and as a result, the manhole lid 10 is not interfered by the front frame 22 of the manhole lid support frame 20.

In the straight line insertion scheme in the prior art in which the front part is opened, advance directions of both side protrusion parts 15 and 15 are the same as the straight directions of both side frames 24 and 24 and simultaneously, since the manhole lid 10 is a rectangular manhole without the front protrusion part, a concerned element concerned in the hinge-coupling structure is extremely simple unlike a curve insertion scheme of a circular manhole.

The hinge-coupling structure of the straight line insertion scheme in the prior art in which the front part is opened will be described.

The hinge-coupling structure in the straight line insertion scheme having a rectangular structure is a structure formed by the S-shaped hinge groove 30 and hinge projection portion 40.

A state in which the hinge projection portion 40 located at O is a state in which the manhole lid 10 is completely closed.

Both side protrusion parts 15 and 15 of the manhole lid 10 are advanced straightly while moving to *P. The straight advance of both side protrusion parts 15 and 15 is the same straight directions of both side frames 24 and 24 of the manhole lid support frame 20.

P→O is also established, which is a reverse order of O→P. In the case of P→O, both side protrusion parts 15 and 15 straightly move backward and move down while the manhole lid 10 is slowly closed. P→O is a reverse action to O→P.

Since both side protrusion parts 15 and 15 of the manhole lid 10 move forward and backward in the straight direction and since both side frames 24 and 24 of the manhole lid support frame 20 corresponding to both side protrusion parts 15 and 15 also move forward and backward, the hinge-coupling structure of the straight line insertion scheme having the rectangular structure in the prior art in which the front part is opened is a structure to solve interference in the straight direction.

In the case of the curve insertion scheme of the circular structure, a problem of interference due to the circular curved protrusion part cannot be solved by the hinge-coupling structure of the straight line insertion scheme of the rectangular structure. Unlike the straight line insertion scheme of the rectangular structure, in the curve insertion scheme of the circular structure, one core is to have a precise and detailed hinge-coupling structure for each of interference positions on an arc because there are a large number of interference positions on the arc and the other core is to give the rotational inclination angle to the circular protrusion part for each of innumerable interference positions present on the arc.

It is impossible to solve the problem of innumerable interference on the arc by the straight line insertion scheme having the rectangular structure.

There is a limit to the hinge-coupling structure of the straight line insertion scheme having the rectangular structure in the prior art herein.

The limit is the problem of the hinge-coupling structure of the straight line insertion scheme having the rectangular structure in the prior art against the curve insertion scheme of the circular structure.

### DISCLOSURE

### Technical Problem

(a) An object of the present invention is to overcome innumerable interferences on arcs through a curve insertion scheme of a circular structure, that is, a curve insertion scheme by a rotational inclination angle θ of the edge protrusion part 31 and an operation model view of an S-shaped hinge curve part 33 when a circular lid body 30 is opened or closed by a hinge-coupling structure at an eccentric location out of a circle, the circular lid body 30 can be opened or closed without interference between an edge protrusion part 31 of the circular lid body 30 and a circular edge support frame 12 of a support frame body 10.

(b) In addition, another object is that an operation model view of the S-shaped hinge curve part 33 is made to be a curve formed by a mutual relationship with a center line (vertical line) of a circumferential center M, and as a result, it is easy to obtain a rotational inclination angle θ of a third equal splitting point without interference of the edge protrusion part 31 depending on length changes ΔX and ΔZ of the S-shaped hinge curve part 33.

(c) Yet another object is that the rotational inclination angle without interference of the edge protrusion part 31 of an n-th equal splitting point of each of respective three equally divided points (M-S1, S1-S2, . . . ) is obtained and is sequentially added and subtracted and distributed by each Δθ/n obtained by n-dividing a difference inclination angle Δθ in rotational inclination angle between both three divided points to easily obtain an entire rotational inclination angle of the edge protrusion part 31 through the three equally divided points.

### Technical Solution

A configuration of a system for manufacturing a polymer circular manhole assembly in which a circular edge protrusion part of a lid body and a circular edge support frame of a support frame body are insertable without mutual interference, ejection of the lid body due to backflow is prevented according to the present invention is described below.

In a system for manufacturing a polymer circular manhole assembly in which a circular edge protrusion part of a lid body and a circular edge support frame of a support frame body are insertable without mutual interference, ejection of the lid body due to backflow is prevented, in which a circular lid body 30 having an edge protrusion part 31 with a height h and a support frame body 10 having an edge support frame 12 with a height h are opened or closed, a hinge portion 32 is formed integrally with a lid body 30 while being located out of a circle of the lid body 30 and a hinge frame 15 corresponding to the hinge portion 32 is formed integrally with the hinge frame 15 while being located out of the circle of the support frame body 10 constituted by a hinge frame 152, a bottom plate 155, and a rear surface frame 154, in this case, an S-shaped hinge curve part 33 is formed on a side part 322 of the hinge portion 32, a hinge axis 152a formed integrally with the hinge frame 152 of the hinge frame 15 is inserted into the S-shaped hinge curve part 33 to form a hinge-coupling structure, in an operation model view of the S-shaped hinge curve part 33, point A is determined at a position oft (=15 mm) on a CE line in a square D, C, E, and q of h×h (50 mm×50 mm), a circle having a radius R (=9.5 mm [radius r of rotational axis+tolerance]) is drawn around point A, a point which meets a horizontal line of A is n, m, a point where line Eq meets each 5-degree line drawn inward from D is W, a vertical line j is drawn toward A to be parallel to two equally divided vertical lines of a CD line with an interval of qW/2(=4 mm/2), a horizontal line l is drawn up at a height of R/2 (=9.5 mm/2)parallel to the horizontal line of A, a straight line g-g linking points B and W is drawn, where the vertical line j and the horizontal line l meet, arc ma, arc AK, and arc nb are drawn around a circle of point B, a, K, and b are points which meet the straight line g-g, arc be, arc Kd, and arc ac are drawn around the circle of point W again, in this case, a curve having a route of a curve AFJKe formed by curve mac and curve nbe and in which the center of the hinge axis 152a moves is the S-shaped hinge curve part 33, meanwhile, a ½ circle is divided to be symmetric based on a P-O line of the lid body 30 and three equally divided points (P, S4, S3, M, S1, S2, and O) around the center M of the circumference of the ½ circle are determined, further, a rotational inclination angle θ of the three equally divided points is determined, M is a specific reference point, a center line of M is a vertical line in which the rotational inclination angle of the edge protrusion part 31, θ=0 degree, the S-shaped hinge curve part 33 is a structure having a route for the reference point M, in respect to the rotational inclination angle θ of the three equally divided points, θ of S1=9 degrees, θ of S2=18 degrees, θ of O=23 degrees, θ of S3=21 degrees, θ of S4=22 degrees, and θ of P=26 degrees, in n-dividing each of three equally divided points (M-S1, S1-S2, . . . ) and obtaining the rotational inclination angle of each n equally divided point, each Δθ/n obtained by n-dividing a difference inclination angle Δθ in rotational inclination angle between both three divided points (M-S1, S1-S2, . . . ) is sequentially added or subtracted and distributed with respect to each of respective three equally divided points (M-S, S1-S2, . . . ) to determine the rotational inclination angle of the edge protrusion part 31 of each n equally divided point, meanwhile, while a magnitude of the rotational inclination angle of the edge support frame 12 of the support frame body 10 is the same as the magnitude of the rotational inclination angle of the edge protrusion part 31 corresponding thereto and directions thereof are opposite to each other.

In addition, in the system for manufacturing a polymer circular manhole assembly in which a circular edge protrusion part of a lid body and a circular edge support frame of a support frame body are insertable without mutual interference, ejection of the lid body due to backflow is prevented, the inclination angle θ of the center line of M is set to be equal to 2 to 3 degrees.

Moreover, in the system for manufacturing a polymer circular manhole assembly in which a circular edge protrusion part of a lid body and a circular edge support frame of a support frame body are insertable without mutual interference, ejection of the lid body due to backflow is prevented, a reinforcing liner 40 is integrally formed on a back surface of the lid body 30 and an abdomen is convex from the edge protrusion part 31 toward the center.

### Advantageous Effects

(a) An effect of the present invention is that since the edge protrusion part 31 of the circular lid body 30 is opened/closed with respect to the circular edge support frame 12 of the support frame body 10 through a curve insertion scheme of a circular structure, that is, an operation model view of an S-shaped hinge curve part 33 and a curve insertion scheme by a rotational inclination angle θ of the edge protrusion part 31 when a circular lid body 30 is opened or closed by a hinge-coupling structure at an eccentric location out of a circle, innumerable interferences on arcs are overcome.

(b) In addition, an effect is that an operation model view of the S-shaped hinge-curve part 33 is made to be a curve formed by a mutual relationship with a center line (vertical line) of a circumferential center M, and as a result, it is easy to obtain a rotational inclination angle θ of a third equal splitting point without interference of the edge protrusion part 31 depending on length changes ΔX and ΔZ of the S-shaped hinge curve part 33.

(c) An effect is that the rotational inclination angle without interference of the edge protrusion part 31 of an n-th equal splitting point of each of respective three equally divided points (M-S1, S1-S2, . . . ) is obtained and is sequentially added and subtracted and distributed by each Δθ/n obtained by n-dividing a difference inclination angle Δθ in rotational inclination angle between both three divided points to easily obtain an entire rotational inclination angle of the edge protrusion part 31 through the three equally divided points.

(d) An effect of the present invention is that the lid body 30 is prevented from being separated due to the backflow during flood by the hinge-coupling structure constituted by the S-shaped hinge curve part 33 and the hinge axis 152a.

### DESCRIPTION OF DRAWINGS

FIG. 1A is an exploded perspective view of a manhole assembly of a straight line insertion scheme in the related art.

FIG. 1B is a state diagram illustrating a state of an initial opening/closing stage of a manhole lid by a hinge structure of the straight line insertion scheme in the related art.

FIG. 1C is a state diagram illustrating a state of a latter opening/closing stage of a manhole lid by a hinge structure of the straight line insertion scheme in the related art.

FIGS. 2A and 2B are perspective views illustrating a state in which a lid body of a circular edge protrusion part is opened in a support frame body of a circular edge support frame according to the present invention.

FIG. 2C is a perspective view illustrating a state in which the lid bodies of FIGS. 2A and 2B are closed.

FIG. 3A is a perspective view of the support frame body of the circular edge support frame according to the present invention.

FIG. 3B is a perspective view of the lid body of the circular edge protrusion part according to the present invention.

FIG. 3C is a cross-sectional view illustrating a cross section in a state in which the lid bodies of FIGS. 2A and 2B are closed.

FIG. 4 is a perspective view of a circular lid body illustrating a state in which an S-shaped hinge curve part is formed on a side surface of a hinge portion according to the present invention.

FIG. 5 is a cross-sectional state diagram illustrating a state in which a hinge axis formed in a hinge frame of a support frame body is inserted into the S-shaped hinge curve part formed in the hinge portion of the circular lid body and the lid body rotates according to the present invention.

FIG. 6 is an operation model view of the S-shaped hinge curve part according to the present invention.

FIG. 7A is a perspective view illustrating three equally divided points for obtaining a rotational inclination angle θ in a state in which the circular lid body is completely closed with respect to the support frame body according to the present invention.

FIG. 7B illustrates a rotational inclination angle illustrated at three equally divided points of the edge protrusion part of the lid body with rotation of the circular lid body around M of FIG. 7A.

FIG. 8A is a perspective view illustrating a state in which the circular lid body is gradually opened on the support frame body.

FIG. 8B is a cross-sectional view illustrating a rotational angle with opening of the lid body of FIG. 8A.

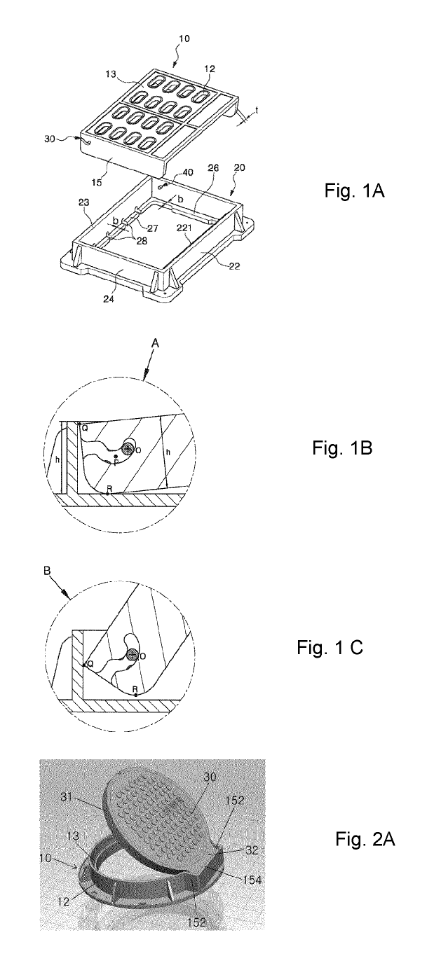

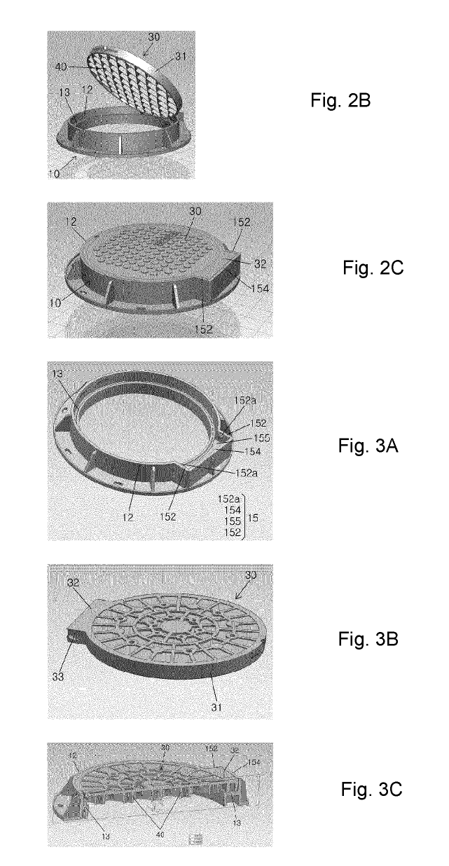

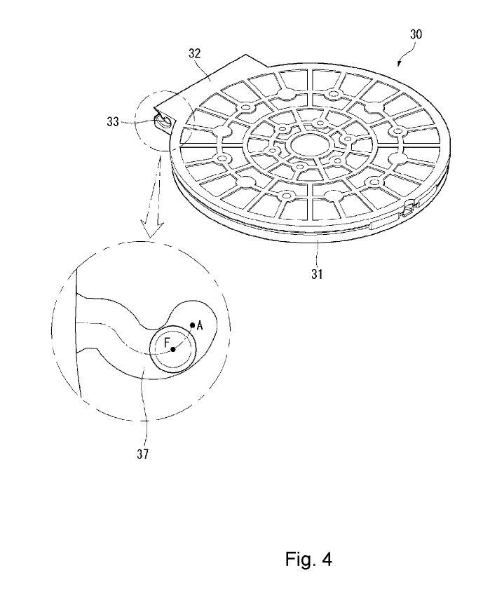

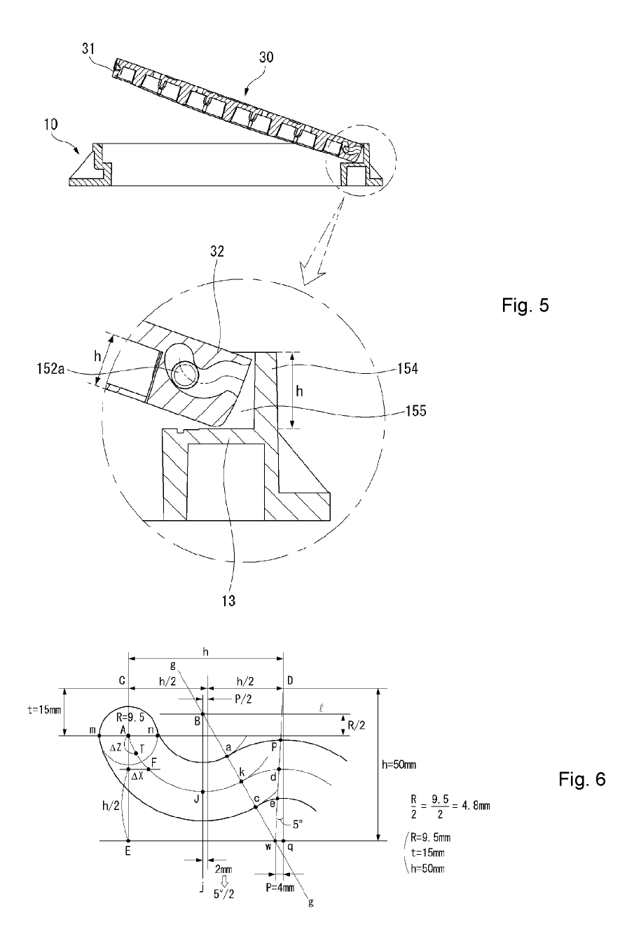

### MODES OF THE INVENTION

A curve insertion scheme of a circular structure according to the present invention is a scheme that smoothly opens and closes a circular lid body 30 without interference by a hinge-coupling structure and a rotational inclination angle of an edge protrusion part 31 of a circular lid body 30 against innumerable interference on an arc.

The present invention has been made in an effort to overcome innumerable interferences on arcs by a hinge axis 152a of an eccentric position, a hinge-coupling structure, and a rotational inclination angle of the edge protrusion part 31 of the circular lid body 30.

The edge protrusion part 31 of the circular lid body 30 is supported by a horizontal support part 13 of a support frame body 10. In this case, the lid body 30 is completely closed.

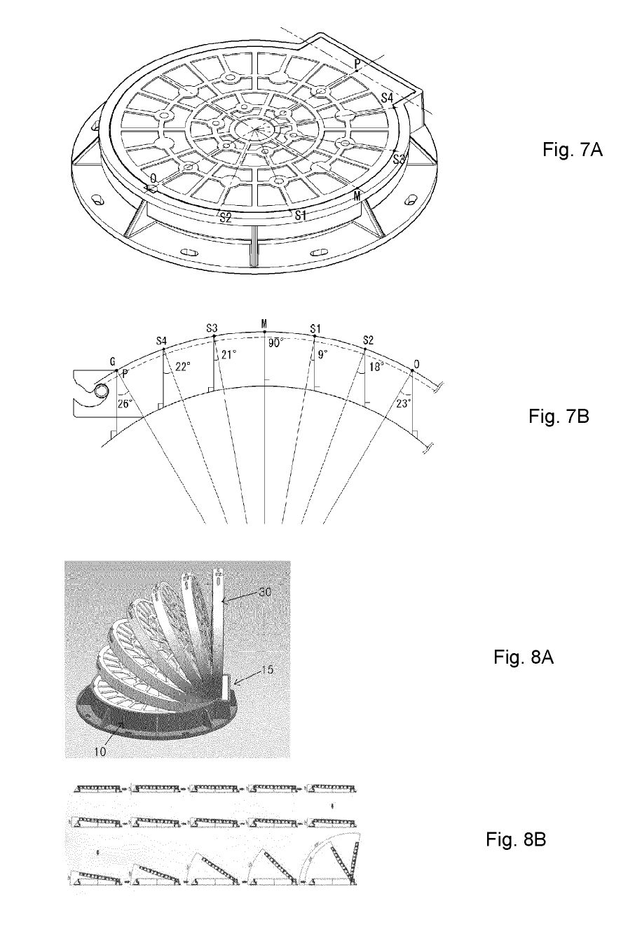

As illustrated in FIG. 7A, a P-O direction at a rotational angle of 0 degree (completely closed state) of the lid body 30 is referred to as an X axis and an upward vertical line direction is referred to as a Z axis. Original points of the X and Z axes are the hinge axis 152a point.

A hinge frame 15 of the present invention is formed integrally with the support frame body 10 at an eccentric position out of the circular support frame body 10.

A hinge portion 32 of the circular lid body 30 is formed integrally with the lid body 30 at the eccentric position out of the circular lid body 30.

The hinge frame 15 of the support frame body 10 corresponds to the hinge portion 32 of the circular lid body 30. The reason is that the hinge portion 32 is inserted into the hinge frame 15 to be hinge-coupled.

An S-shaped hinge curve part 33 is formed on a side part 322 of the hinge portion 32. The hinge axis 152a formed integrally with the hinge frame 15 is inserted into the S-shaped hinge curve part 33. The hinge axis 152a is a fixation axis which is not movable. The S-shaped hinge curve part 33 actually moves with the hinge axis 152a as a fixation point. The movement of the S-shaped hinge curve part 33 is the movement of the lid body 30. The reason is that only the S-shaped hinge curve part 33 is not movable without the movement of the lid body 30.

A relationship between the hinge axis 152a and the S-shaped hinge curve part 33 is illustrated in FIG. 6.

A center line of the S-shaped hinge curve part 33 is line A→F→J→K→d. A center of the hinge axis 152a moves along the center line A→F→J→L→d. Actually, the center line of the S-shaped hinge curve part 33 moves on the fixation point of the hinge axis 152a. For an easy description by FIG. 6, it is illustrated that the S-shaped hinge curve part 33 is fixed and the hinge axis 152a moves. Since the fixation and the movement are relative actions, there is no contradiction.

First, a structure of the S-shaped hinge curve part 33 is described.

The circular lid body 30 is rotated and opened around the hinge axis 152a of the hinge frame 15. The hinge axis 152a is inserted into the S-shaped hinge curve part 33.

The hinge portion 32 of the circular lid body 30 is located on a rear surface part and the circular lid body 30 is located on a front surface part based on the hinge axis 152a. The hinge portion 32 of the lid body 30 rotates in the hinge frame 15 without mutual interference by the hinge-coupling structure of the hinge axis 152a and the S-shaped hinge curve part 33 and in addition, an edge protrusion part 31 of the circular lid body 30 rotates without interference with an edge support frame 12 of the support frame body 10.

The S-shaped hinge curve part 33 is a structure that satisfies a rotational condition of each of the front and rear surface parts.

The rotational condition of the front surface part is a condition to overcome innumerable positional interference on the arc and the rotational condition of the rear surface part is a condition that the hinge portion 32 rotates in the hinge frame 15 without the interference.

The front surface part is a curve insertion scheme on the arc shape unlike the straight line insertion scheme of the rectangular structure in the prior art.

It is the structure of the S-shaped hinge curve part 33 that enables the curve insertion scheme on the arc of the front surface part.

Since it is the structure of the S-shaped hinge curve part 33 that satisfies the rotational conditions of the front and rear surface parts and in particular, overcomes interference points even though there are innumerable interference points on the arc of the front surface part unlike a straight line, an accurate and precise operation model view of the S-shaped hinge curve part 33 for overcoming the interference points is required.

The operation model view will be described below.

The operation model view shows the structure for the S-shaped hinge curve part 33 when heights of the circular edge protrusion part 31 and edge support frame 12 are h. Materials of the circular lid body 30 and the support frame body 10, the edge protrusion part 31 and the edge support frame 12, and the S-shaped hinge curve part 33, and the hinge axis 152a are polymer series.

The materials will be described with reference to FIG. 6.

\textcircled{1} Squares D, C, E, and q of h×h are drawn. FIG. 6 illustrates a case of h=50 mm as an example.

\textcircled{2} A point below at point C by t (=15 mm) is called A.

A is a position of the hinge axis 152a when the lid body 30 is completely closed. t is for that a surface of the lid body 30 and an upper end of edge support frame 12 of the support frame body 10 to be located on the same plane.

\textcircled{3} A circle with a radius R (=9.5 mm) around point A and a point with a horizontal line of A is called n, m.

Herein, the radius R is a value obtained by adding tolerance to a radius r of the hinge axis 152a. The tolerance is preferably 1 mm. For example, the radius R is set to 9.5 mm.

\textcircled{4} A straight line of 5 degrees inward from a corner D of a square and a point met by a line segment Eq is referred to as W.

In this case, a line segment which meets a line of an angle of 5 degrees at h=50 mm, qW=4 mm.

In order to prevent a lower corner of the lid body 30 from being interfered by a bottom plate 155 of the hinge frame 15, the angle of 5 degrees is given inward.

\textcircled{5} A vertical line j is drawn toward A parallel to two equally divided vertical lines of line segment CD and an interval thereof is made to be qW/2. Herein, qW/2=2 mm.

The reason is that a corner q moves to point W due to the angle of 5 degrees.

\textcircled{6} A horizontal line l is drawn up at a height of R/2 parallel to the horizontal line of A. Herein, R/2=9.5 mm/2.

\textcircled{7} Drawn is a straight line g-g linking points B and W where the vertical line j and the horizontal line l meet.

\textcircled{8} Arc ma, arc AK, and arc nb are drawn around a circle of point B.

a, K, and b are points which meet the straight line g-g.

\textcircled{9} Arc be, arc Kd, and arc ac are drawn around the circle of point W.

c, d, and e are points which meet a straight line W-D.

\textcircled{10} The S-shaped hinge curve part 33 is a structured formed by curve mac and curve nbe.

Curve AFJKe is a route where the center of the hinge axis 152a moves.

Next, characteristics of routes that simultaneously satisfy the respective rotational conditions of the front and rear surface parts will be described below with reference to FIG. 6.

The state in which the lid body 30 is completely closed, that is, the position of the hinge axis 152a at a rotational angle of 0 degree is point A.

When the lid body 30 is gradually opened as the rotational angle increases, the hinge axis 152a moves from A toward T→F.

First, the route of A→T is described.

The hinge axis 152a point is the original point of the X and Z axes. The reason is that the hinge axis 152a is the fixation point.

When the hinge axis 152a moves from A to T in the S-shaped hinge curve part 33, on the front surface part, the lid body 30 becomes longer by ΔX from the original point and moves up by ΔZ, and on the rear surface part, the hinge portion 32 becomes shorter by ΔX and moves down by ΔZ.

The reason is that since the hinge axis 152a is not a movable body but the fixation axis, only the lid body 30 by the S-shaped hinge curve part 33 actually moves.

The length change (ΔX, ΔZ) of the front surface part is a relationship between innumerable positional interferences on the arc and the length change (ΔX, ΔZ) of the rear surface part is a relationship between a rear surface frame 154 and a bottom plate 155 of upper and lower corners of the hinge portion 32.

The rotational inclination angle of the edge protrusion part 31 of the circular lid body 30 of the circular shape is an inclination angle corresponding to the length change (ΔX, ΔZ) of the front surface part. The reason is that the rotational inclination angle of the edge protrusion part 31 of the circular shape is the curve insertion scheme on the arc depending on the length change (ΔX, ΔZ) of the front surface part.

The length change (ΔX, ΔZ) of the rear surface part is to prevent the upper corner of the hinge portion 32 from being interfered by the rear surface frame 154 while rotation and the lower corner from being interfered by the bottom plate 155.

In this case, even though the hinge portion 32 of the rear surface part moves down by ΔZ, the lower corner of the hinge portion 32 is not interfered by the bottom plate 155. The reason is that while the hinge portion 32 is shorter by ΔX (that is, moves up), ΔZ moves down. There is a balance of move-up and move-down in the S-shaped hinge curve part 33.

Second, the route of T→F is described.

A characteristic of point T of the length change (ΔX, ΔZ) of the front and rear surface parts in the A→T route and a characteristic of point F of the front and rear surface parts in the T→F route are the same as each other.

However, at the moment when the lid body 30 reaches point F, the length change (ΔX, ΔZ) of the front and rear surface parts disappears and only an opening rotational angle of the lid body 30 remains.

The face that there is no length change (ΔX, ΔZ) of the front and rear surface parts means a state in which the edge protrusion part 31 and the edge support frame 12 do not interfere with each other, that is, a state in which the edge protrusion part 31 of the lid body 30 completely deviates from the edge support frame 12 of the support frame body 10 (see FIG. 6). Since the length change is not required any longer at a branch point F where the interference is canceled, only an opening rotation function is provided.

In this sense, F is referred to as branch point F.

At the branch point F, there is no length change (ΔX, ΔZ) of the front and rear surface parts and only the opening rotational angle of the lid body 30 remains. At the branch point F, a minimum opening angle of the lid body 30 is 34.5 degrees and a maximum opening angle is 150 degrees (see FIG. 8B).

In the A→F route, the opening rotation angle of the lid body 30 is in the range of 0 to 34.5 degrees. In the F→J→K route, the opening rotation angle of the lid body 30 is in the range of 34.5 to 150 degrees. There is the length change (ΔX, ΔZ) of the lid body 30 and the hinge portion 32 at 0 to 34.5 degrees.

The hinge axis 152a needs to be maintained at the branch point F in order to maintain the open rotation angle of 34.5 to 150 degrees at the branch point F. The reason is that when the hinge axis 152a easily escapes from the branch point F and is directed to the J side, the hinge-coupling structure is not normally operated and the lid body 30 does not rotate and when the lid body 30 is forcibly rotated, the hinge-coupling structure is broken.

Due to the above, a small suspension jaw is formed so as to prevent the branch point F from being easily released to the J side.

Third, disassembly of the lid body 30 is described below.

At the branch point F, the lid body 30 has the opening rotation angle of 34.5 to 150 degrees. The rear surface frame 154 does not rotate any longer. In this case, the supported opening rotation angle is in the range of 120 to 150 degrees.

The lid body 30 is supported on the rear surface frame 154 at the branch point F. In this case, the hinge axis 152a is at the branch point F and a support point M of the lid body 30 is at the upper end of the rear surface frame 154. The lid body 30 is located on the upper side of the support point M and the hinge axis 152a of the branch point F is located on the lower side of the support point M. This is a lever in which an upper length of the support point M is longer than a lower length thereof. When horizontal strong force is applied to the upper side of the support point M, the hinge axis 152a is ejected to K through J while the hinge axis 152a is released from the branch point F. The hinge axis 152a that reaches K has already lost coupling force. When the lid body 30 is pulled up, the lid body 30 is easily released and disassembled.

Here, in order to allow the hinge axis 152a of the branch point F to come out of the small suspension jaw, large force exerted by a leverage principle by the strong force in the horizontal direction is required. The reason is that the hinge axis 152a may not escape from the suspension jaw without the large force exerted in the leverage principle. Such a hinge-coupling structure is advantageous in that the lid body 30 is prevented from being separated due to the backflow during flood.

Fourth, A→F→J→K is a route from opening to disassembly of the lid body 30. K→J→F→A is a route in which the lid body 30 is inserted. The insertion route is a reverse order to a disassembly route. The reverse order is also established.

However, an inclination of the small suspension jaw is a steep inclination with respect to the disassembly route and a gentle inclination with respect to the insertion route. Unlike the disassembly route using the leverage principle, in the insertion route, the lid body 30 is easily inserted when a strong force is applied.

Meanwhile, the rotational inclination angle of the edge protrusion part 31 of the lid body 30 of the circular shape is an inclination angle corresponding to the length change (ΔX, ΔZ) of the front surface part.

In the curve insertion scheme corresponding to the length change (ΔX, ΔZ) of the front surface part in the length of the front part, the edge protrusion part 31 of the circular shape should not interfere with the circular edge support frame 12 of the support frame body 10. To this end, the circular edge protrusion part 31 should be provided with the rotational inclination angle.

First, as illustrated in FIG. 7A, the lid body 30 is made to be symmetrical with respect to a P-O line of the lid body 30 in a completely closed state with a ½ circle. The center of a circumference of one half circle is M. Three equally divided points around the center M of the circumference of the ½ circle are called P, S4, S3, M, S1, S2, and O.

The rotational inclination angle of the circular edge protrusion part 31 is an inclination angle θ to the vertical line of the lid body 30 as illustrated in FIG. 7B. FIG. 7B is a plan view of the edge protrusion part 31 of the ½ circle.

Next, the edge protrusion part 31 of the circumferential center M has no rotational inclination angle (θ=0 degree).

That is, the edge protrusion part 31 of M is vertical to the lid body 30.

The length change (ΔX, ΔZ) of the S-shaped hinge curve part 33 is an operation model view created based on M of the circular edge protrusion part 31.

The circumferential center M is a linkage with the operation model view of the S-shaped hinge curve part 33.

The reason is that the circular edge protrusion part 31 is inserted without interference in the M.

Since the rotational inclination angle θ is 0 degree, the center line of the M is a vertical line V.

The rotational inclination angle θ of three equally divided points based on the center line V of M is as follows.

The rotational inclination angle of S1, θ=9 degrees, the rotational inclination angle of S2, θ=18 degrees, the rotational inclination angle of O, θ=23 degrees, the rotational inclination angle of S3, θ=21 degrees, the rotational inclination angle of S4, θ=22 degrees, and the rotational inclination angle of P, θ=26 degrees.

The rotational inclination angle θ becomes larger as it goes away from M. Further, point P of the hinge axis 152a of the lid body 30 has a larger rotational inclination angle than point O.

The rotational inclination angle of three equally divided points around M is a rotational angle at which the lid body 30 is insertable without interference.

The rotational inclination angle among the respective three equally divided points may be obtained by adding or subtracting Δθ/n to or from a difference Δθ in rotational inclination angle of both three equally divided points. n means n-dividing the respective three equally divided points.

For example, between M and S3, the rotational inclination angle of the center line M, θ=0 degree and the rotational inclination angle of S3, θ=21 degrees. A difference in rotational inclination angle between M and S1, Δθ=21 degrees. When the difference is n-divided, 21 degrees/n is obtained.

A start point of n-dividing is set to M and an end point is set to S3.

The rotational inclination angle of each n equally divided point from M as the start point up to S3 as the n-divided end point is as follows.

$$θ of point M = 0 degree , \\ θ of point ( M + 1 / n ) = ( 21 degrees \times 1 / n ) , \\ θ of point ( M + 2 / n ) = ( 21 degrees \times 2 / n ) , \\ ⋮$$

$$S 3 = θ of point ( M + n / n ) = ( 21 degrees \times n / n ) = 21 degrees$$

There are two schemes of distributing the rotational inclination angle of n equal division between M and S3 depending on the start point and the end point.

The start point of distribution is M and the end point is S3 (M→S3) and the start point is S3 and the end point is M (S3→M).

Since the rotational inclination angle tends to gradually increase toward S3 in the case of M→S3, the case of M→S3 is a distribution scheme that adds Δθ/n to the rotational inclination angle of M.

Since the rotational inclination angle tends to gradually decrease toward M in the case of S3→M, the case of S3→M is a distribution scheme that subtracts Δθ/n to the rotational inclination angle of S3.

Since the rotational inclination angle of each n equally divided point among the respective three equally divided points may be obtained through such distribution, the rotational inclination angle of the entire circular edge protrusion part 31 may be obtained.

Since the other semicircle is also symmetric thereto, the rotational inclination angle of the edge protrusion part 31 is the same.

As described above, the rotational inclination angle of each n equally divided point by n-dividing a difference Δθ between the rotational inclination angle of three equally divided points with the center line (θ=0 degree) of M and the rotational inclination angle among the respective three equally divided points and adding or subtracting Δθ/n degrees to or from the rotational inclination angle of the start point of respective three equally divided points.

Further, the rotational inclination angle of the edge protrusion part 31 of the lid body 30 of each of n equally divided points is a rotational inclination angle corresponding to the edge support frame 12 of the support frame body 10. Further, the rotational inclination angle corresponding to the edge support frame 12 of the support frame body 10 of each of n equally divided points is an angle inclined according to the rotational inclination angle of the edge protrusion part 31 of the lid body 30. The rotational inclination angle of the edge protrusion part 31 of the lid body 30 of each of n equally divided points and the rotational inclination angle of the edge support frame 12 of the support frame body 10 engage with each other, and as a result, sealing and strong support are formed.

To sum up this, the ½ circle is symmetrically divided with respect to the P-O line of the lid body 30, and the three equally divided points P, S4, S3, M, S1, S2, and O with the circumferential center M of the ½ circle are determined, the rotational inclination angle θ of the three equally divided points, M is a specific reference point, the center line of M is a vertical line in which rotational inclination angle of the edge protrusion part 31, θ=0 degree, the S-shaped hinge curve part 33 is a structure having the route for the reference point M, θ of S1=9 degrees, θ of S2=18 degrees, θ of O=23 degrees, θ of S3=21 degrees, θ of S4=22 degrees, and θ of P=26 degrees with respect to the rotational inclination angle θ of the three equally divided points, and in the case of the distribution of the rotational inclination angle among the respective three equally divided points, the rotational inclination angle of each of n equally divided points may be obtained by n-dividing the difference Δθ in rotational inclination angle of both three equally divided points and gradually adding or subtracting Δθ/n degrees.

It is also preferable to set the inclination angle θ of the center line of M to be equal to 2 to 3 degrees. This causes the center line of M to be inserted smoothly into the edge support frame 12 of the support frame body 10.

In addition, a reinforcing liner 40 is integrally formed on a back surface of the lid body 30 as illustrated in FIG. 10.

A shape of the reinforcing liner 40 is a structure in which an abdomen is convex from the edge protrusion part 31 of the lid body 30 toward the center. The reason is that a load is large at the center. It is preferable to arrange the reinforcing liner 40 in a lattice form. This is to double the magnitude of the supporting force with respect to an upper load.

1. A system for manufacturing a polymer circular manhole assembly in which a circular edge protrusion part of a lid body and a circular edge support frame of a support frame body are insertable without mutual interference, ejection of the lid body due to backflow is prevented, comprising:
a circular lid body having an edge protrusion part with a height h (=50 mm) and a support frame body having an edge support frame with a height h (=50 mm) are opened or closed, and
a hinge portion is formed integrally with a lid body while being located out of a circle of the lid body and a hinge frame corresponding to the hinge portion is formed integrally with the hinge frame while being located out of the circle of the support frame body constituted by a hinge frame, a bottom plate, and a rear surface frame, in this case, an S-shaped hinge curve part is formed on a side part of the hinge portion, a hinge axis formed integrally with the hinge frame of the hinge frame is inserted into the S-shaped hinge curve part to form a hinge-coupling structure, in an operation model view of the S-shaped hinge curve part, point A is determined at a position of t (=15 mm) on a CE line in a square D, C, E, and q of h×h (50 mm×50 mm), a circle having a radius R (=9.5 mm) is drawn around point A, a point which meets a horizontal line of A is n, m, a point where line Eq meets each 5-degree line drawn inward from D is W, a vertical line j is drawn toward A to be parallel to two equally divided vertical lines of a CD line with an interval of qW/2(=4 mm/2), a horizontal line l is drawn up at a height of R/2(=9.5 mm/2)parallel to the horizontal line of A, a straight line g-g linking points B and W is drawn, where the vertical line j and the horizontal line l meet, arc ma, arc AK, and arc nb are drawn around a circle of point B, a, K, and b are points which meet the straight line g-g, arc be, arc Kd, and arc ac are drawn around the circle of point W again, in this case, a curve having a route of a curve AFJKe formed by curve mac and curve nbe and in which the center of the hinge axis moves is the S-shaped hinge curve part, meanwhile, a ½ circle is divided to be symmetric based on a P-O line of the lid body and three equally divided points (P, S4, S3, M, S1, S2, and O) around the center M of the circumference of the ½ circle are determined, further, a rotational inclination angle θ of the three equally divided points is determined, M is a specific reference point, a center line of M is a vertical line in which the rotational inclination angle of the edge protrusion part, θ=0 degree, the S-shaped hinge curve part is a structure having a route for the reference point M, in respect to the rotational inclination angle θ of the three equally divided points, θ of S1=9 degrees, θ of S2=18 degrees, θ of O=23 degrees, θ of S3=21 degrees, θ of S4=22 degrees, and θ of P=26 degrees, in n-dividing each of three equally divided points (M-S1, S1-S2, . . . ) and obtaining the rotational inclination angle of each n equally divided point, each Δθ/n obtained by n-dividing a difference inclination angle Δθ in rotational inclination angle between both three divided points (M-S1, S1-S2, . . . ) is sequentially added or subtracted and distributed with respect to each of respective three equally divided points (M-S1, S1-S2, . . . ) to determine the rotational inclination angle of the edge protrusion part of each n equally divided point, meanwhile, while a magnitude of the rotational inclination angle of the edge support frame of the support frame body is the same as the magnitude of the rotational inclination angle of the edge protrusion part corresponding thereto and directions thereof are opposite to each other.

2. The system for manufacturing a polymer circular manhole assembly in which a circular edge protrusion part of a lid body and a circular edge support frame of a support frame body are insertable without mutual interference, ejection of the lid body due to backflow is prevented of claim 1, wherein the inclination angle θ of the center line of M is set to be equal to 2 to 3 degrees.

3. The system for manufacturing a polymer circular manhole assembly in which a circular edge protrusion part of a lid body and a circular edge support frame of a support frame body are insertable without mutual interference, ejection of the lid body due to backflow is prevented of claim 1, wherein a reinforcing liner is integrally formed on a back surface of the lid body and an abdomen is convex from the edge protrusion part toward the center.

4. A polymer circular manhole assembly in which a circular edge protrusion part of a lid body and a circular edge support frame of a support frame body are insertable without mutual interference, ejection of the lid body due to backflow is prevented, comprising
a circular lid body having an edge protrusion part with a height h and a support frame body having an edge support frame with a height h are opened or closed, and
a hinge portion is formed integrally with a lid body while being located out of a circle of the lid body and a hinge frame corresponding to the hinge portion is formed integrally with the hinge frame while being located out of the circle of the support frame body constituted by a hinge frame, a bottom plate, and a rear surface frame, in this case, an S-shaped hinge curve part is formed on a side part of the hinge portion, a hinge axis formed integrally with the hinge frame of the hinge frame is inserted into the S-shaped hinge curve part to form a hinge-coupling structure, in an operation model view of the S-shaped hinge curve part, point A is determined at a position oft (=15 mm) on a CE line in a square D, C, E, and q of h×h (50 mm×50 mm), a circle having a radius R (=9.5 mm) is drawn around point A, a point which meets a horizontal line of A is n, m, a point where line Eq meets each 5-degree line drawn inward from D is W, a vertical line j is drawn toward A to be parallel to two equally divided vertical lines of a CD line with an interval of qW/2(=4 mm/2), a horizontal line l is drawn up at a height of R/2 (=9.5 mm/2) parallel to the horizontal line of A, a straight line g-g linking points B and W is drawn, where the vertical line j and the horizontal line l meet, arc ma, arc AK, and arc nb are drawn around a circle of point B, a, K, and b are points which meet the straight line g-g, arc be, arc Kd, and arc ac are drawn around the circle of point W again, in this case, a curve having a route of a curve AFJKe formed by curve mac and curve nbe and in which the center of the hinge axis moves is the S-shaped hinge curve part, meanwhile, a ½ circle is divided to be symmetric based on a P-O line of the lid body and three equally divided points (P, S4, S3, M, S1, S2, and O) around the center M of the circumference of the ½ circle are determined, further, a rotational inclination angle θ of the three equally divided points is determined, M is a specific reference point, a center line of M is a vertical line in which the rotational inclination angle of the edge protrusion part, θ=0 degree, the S-shaped hinge curve part is a structure having a route for the reference point M, in respect to the rotational inclination angle θ of the three equally divided points, θ of S1=9 degrees, θ of S2=18 degrees, θ of O=23 degrees, θ of S3=21 degrees, θ of S4=22 degrees, and θ of P=26 degrees, in n-dividing each of three equally divided points (M-S1, S1-S2, . . . ) and obtaining the rotational inclination angle of each n equally divided point, each Δθ/n obtained by n-dividing a difference inclination angle Δθ in rotational inclination angle between both three divided points (M-S1, S1-S2, . . . ) is sequentially added or subtracted and distributed with respect to each of respective three equally divided points (M-S1, S1-S2, . . . ) to determine the rotational inclination angle of the edge protrusion part of each n equally divided point, meanwhile, while a magnitude of the rotational inclination angle of the edge support frame of the support frame body is the same as the magnitude of the rotational inclination angle of the edge protrusion part corresponding thereto and directions thereof are opposite to each other.

5. The polymer circular manhole assembly in which a circular edge protrusion part of a lid body and a circular edge support frame of a support frame body are insertable without mutual interference, ejection of the lid body due to backflow is prevented of claim 4, wherein the inclination angle θ of the center line of M is set to be equal to 2 to 3 degrees.

6. The polymer circular manhole assembly in which a circular edge protrusion part of a lid body and a circular edge support frame of a support frame body are insertable without mutual interference, ejection of the lid body due to backflow is prevented of claim 4, wherein a reinforcing liner is integrally formed on a back surface of the lid body and an abdomen is convex from the edge protrusion part toward the center.
